(19) United States
(12) Patent Application Publication
(10) Pub. No.: US 2013/0080298 A1
(43) Pub. Date: Mar. 28, 2013

(54) SYSTEM AND METHOD FOR PROCESSING A FINANCIAL ACCOUNT

(71) Applicants: Deborah A. Latulipe, Torrington, CT (US); Robin D. Pikor, Avon, CT (US); Jeanette Taylor, Torrington, CT (US)

(72) Inventors: Deborah A. Latulipe, Torrington, CT (US); Robin D. Pikor, Avon, CT (US); Jeanette Taylor, Torrington, CT (US)

(21) Appl. No.: 13/241,926

(22) Filed: Sep. 23, 2011

(51) Int. Cl. G06Q 40/00

(52) U.S. Cl. 705/30

(57) ABSTRACT

According to some embodiments, an inventory report file may be received. The inventory report file may, for example, have records representing outstanding transactions associated with a wealth management record keeping system, and each record in the inventory report file may be associated with a transaction code. Information in a data dictionary may then be accessed, wherein the data dictionary maps transaction codes to accounting categories. A convertor tool may then automatically translate each transaction code in the inventory report file into an appropriate accounting category to facilitate reconciliation of a general ledger account balance.

### BACKGROUND

A wealth management record keeping system may be used to monitor and/or track information associated with financial accounts. For example, a wealth management record keeping system associated with the administration of a mutual fund may receive one or more files from one or more banks. Note that these files may contain hundreds of thousands of individual records, where each record represents a cash transaction associated with the mutual fund. Further note that each record may include one or more transaction identifiers that indicate the nature of the transaction (e.g., one or more alphanumeric codes). These records may need to be matched or reconciled with corresponding customer account adjustment transaction records associated with the mutual fund.

In some cases, however, the system may be unable to match a record with the bank files (or with the customer account adjustment transactions). These records may be stored in an open “inventory” report.

Items in the open inventory report file may be used in connection with an audit process or other reconciliation of a general ledger associated with the mutual fund. To perform such a reconciliation, however, an appropriate accounting category for each record may need to be determined. Further note that different transaction codes may be associated with different accounting categories, and that more than one code may be associated with a single category. Manually determining which records should be associated with which accounting categories can be a time consuming and error prone task.

It would be desirable to provide systems and methods to facilitate wealth management record keeping for a for a financial account in an automated, efficient, and accurate manner.

### SUMMARY OF THE INVENTION

According to some embodiments, systems, methods, apparatus, computer program code and means may be provided to facilitate reconciliation of a general ledger in an efficient and accurate manner. In some embodiments, a data dictionary and convertor tool may be used in connection with a wealth management record keeping system.

According to some embodiments, an inventory report file may be received having records representing outstanding transactions associated with the wealth management record keeping system, wherein each record in the inventory report file is associated with a transaction code. Information in a data dictionary may then be accessed, wherein the data dictionary maps transaction codes to accounting categories. Each transaction code in the inventory report file may then be automatically translated, by a convertor tool, into an appropriate accounting category to facilitate reconciliation of a general ledger account balance.

Some embodiments provide: means for receiving an inventory report file having records representing outstanding transactions associated with the wealth management record keeping system, wherein each record in the inventory report file is associated with a transaction code; means for accessing information in a data dictionary, wherein the data dictionary maps transaction codes to accounting categories; and means for automatically translating, by a convertor tool, each transaction code in the inventory report file into an appropriate accounting category to facilitate reconciliation of a general ledger account balance.

A technical effect of some embodiments of the invention is an improved and computerized method of associated records with appropriate accounting categories. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates a method according to some embodiments of the present invention.

FIG. 3 is a tabular portion of an inventory report file according to some embodiments.

FIG. 4 is a tabular portion of a data dictionary in accordance with some embodiments.

FIG. 5 is a tabular portion of translated transactions according to some embodiments.

FIG. 6 is block diagram of a system according to some embodiments of the present invention.

FIG. 7 illustrates a method according to some embodiments of the present invention.

FIG. 8 is block diagram of a conversion platform according to some embodiments of the present invention.

FIG. 9 is a tabular portion of an inventory report file according to some embodiments.

FIG. 10 is a tabular portion of a data dictionary according to some embodiments.

FIG. 11 is an example of a spreadsheet macro according to some embodiments.

FIG. 12 is a tabular portion of translated transactions according to some embodiments.

FIG. 13 illustrates a display in accordance with some embodiments described herein.

### DESCRIPTION

A wealth management record keeping system may be used to monitor and/or track information associated with financial accounts. For example, a record keeping platform may help facilitate plan administration, reporting, compliance testing, and participant communication associated with a mutual fund or other type of retirement vehicle. Such a wealth management record keeping system may receive a bank file containing records that represent cash transactions associated with the mutual fund (and each record may include one or more transaction identifiers). These records may be matched or reconciled with corresponding customer account adjustment transaction records associated with the mutual fund.

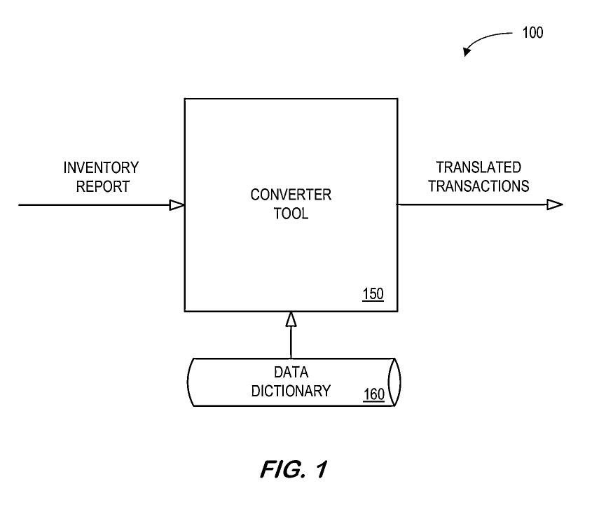

Records that cannot be matched may be placed an open inventory report file. Moreover, items in the open inventory report file may be placed in appropriate accounting categories used in connection with an audit process or other reconciliation of a general ledger associated with the mutual fund. To facilitate an automatic and accurate processing of transaction records, FIG. 1 is a block diagram of a system 100 according to some embodiments of the present invention. In particular, a convertor tool 150 may receive or retrieve an inventory report file. The inventory report file might be locally stored or received from another system or device. The convertor tool 150 might be, for example, associated with a Personal Computers (PC), laptop computer, an enterprise server, a server farm, and/or a database or similar storage devices. The converter tool 150 may, according to some embodiments, be associated with an employer or third-party that administers a retirement plan for employees.

According to some embodiments, an “automated” converter tool 150 may facilitate processing of records in the inventory report file. As used herein, the term “automated” may refer to, for example, actions that can be performed with little or no human intervention.

As used herein, devices, including those associated with the converter tool 150 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The converter tool 150 may also access information in one or more data dictionaries 160. The data dictionary 160 may be locally stored or reside remote from the converter tool 150. As will be described further below, the data dictionary 160 may be used by the converter tool 150 to help categorize records in the inventory report file.

Although a single converter tool 150 is shown in FIG. 1, any number of such devices may be included. Moreover, various devices described herein might be combined according to embodiments of the present invention. For example, in some embodiments, the converter tool 150 and data dictionary 160 might be co-located and/or may comprise a single apparatus.

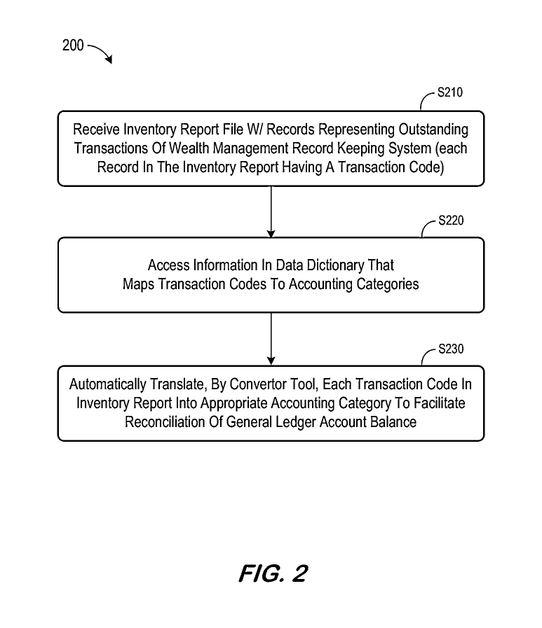

FIG. 2 illustrates a method that might be performed, for example, by some or all of the elements of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, an inventory report file may be received. The inventory report file may have, for example, records representing outstanding transactions associated with a wealth management record keeping system. The wealth management record keeping system might be associated with, for example, any type of wealth annuity management. By ways of examples only, the wealth management system could be associated with a mutual fund, a 401k plan, a 403b plan, a 529 plan, an individual retirement account, and/or a profit sharing plan. According to some embodiments, the wealth management system may be associated with life insurance, such as variable life insurance associated with an underlying equity (e.g., shares of stock) that need to be accounted for. Note that each record in the inventory report file may be associated with a transaction code.

At S220, information in a data dictionary may be accessed. The data dictionary may, for example, map transaction codes to accounting categories. By way of example only, the accounting categories could include a premium transaction, a disbursement transaction, a fee transaction, an outstanding liability transaction, and/or annuity information (e.g., associated with a variable annuity).

At S230, a convertor tool may automatically translate each transaction code in the inventory report file into an appropriate accounting category to facilitate reconciliation of a general ledger account balance. The automatic translating might be, for example, performed periodically, as a batch process, each business day. According to some embodiments, the converter tool is associated with a spreadsheet macro program, such as the EXCEL spreadsheet program available from Microsoft. The macro program might include a “lookup” command, such as a vertical lookup or VLOOKUP command associated with Advanced EXCEL Functionality. An indication of the appropriate accounting category may then be written to a storage device (e.g., a hard disk drive or other storage device).

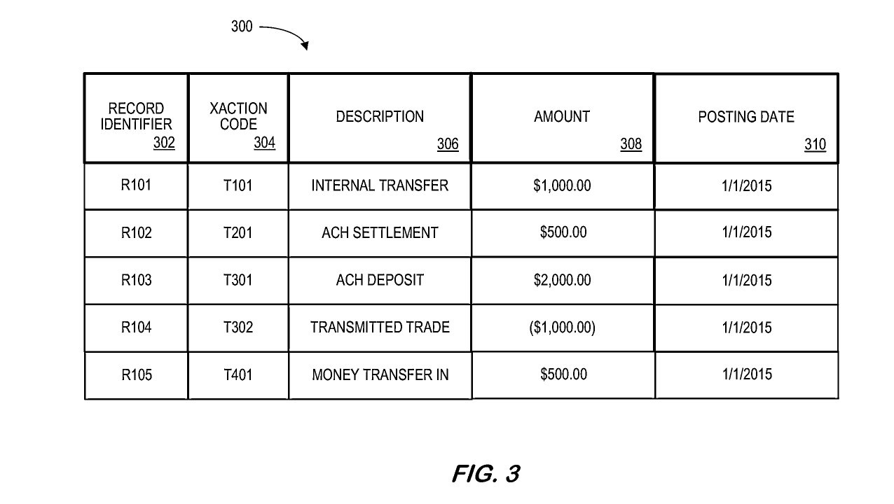

Consider, by way of example, FIG. 3 which is a tabular portion of an inventory report file 300 according to some embodiments. The table may include, for example, entries identifying records that could not be matched and need to be properly categorized to facilitate a reconciliation of a general ledger. The table may also define fields 302, 304, 306, 308, 310 for each of the entries. The fields 302, 304, 306, 308, 310 may, according to some embodiments, specify: a record identifier 302, a transaction code 304, a description 306, an amount 308, and a posting date 310. The information in the inventory report file 300 may be created and updated, for example, whenever a match cannot be found for a record.

The record identifier 302 may be, for example, a unique alphanumeric code identifying an unmatched transaction record. The transaction code 304 may be, for example, an alphanumeric code used by a wealth management record keeping system. The description 306 may provide further details describing the nature of the transaction. For example, the description 306 indicates whether the transaction was associated with an internal transfer or an Automated Clearing House (ACH) settlement. The amount 308 and posting date 310 may, for example, define the monetary value associated with the transaction along with when the transaction was executed.

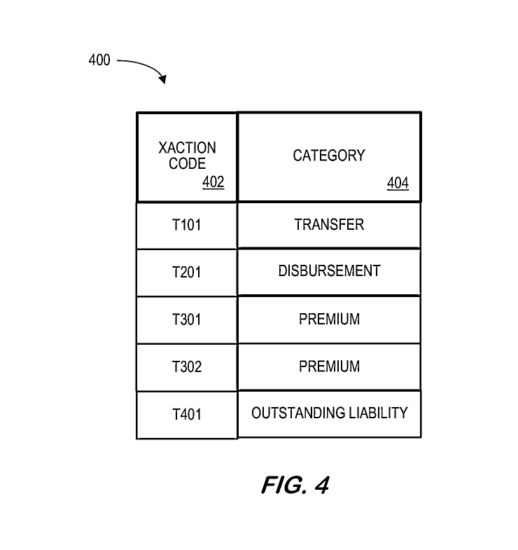

Each record in the inventory report file 300 may need to be placed into an appropriate accounting category. To facilitate this process, FIG. 4 illustrates a tabular portion of a data dictionary 400 that might be used in accordance with some embodiments. The table may include, for example, entries identifying accounting categories that are associated with various transaction codes. The table may also define fields 402, 404 for each of the entries. The fields 402, 404 may, according to some embodiments, specify: a transaction code 402 and a category 404. The information in the inventory report file 400 may be created and updated, for example, by an accountant or administrator whenever codes or accounting categories are adjusted (e.g., a new transaction code is introduced in a wealth management record keeping software upgrade).

The transaction identifier 402 may be a unique alphanumeric code identifying a type of transaction supported by a wealth management record keeping system, and may, according to some embodiments, be based on or otherwise associated with the transaction code 304 in the inventory report file 300. The category 404 may define an appropriate accounting category that should be associated with each transaction identifier 402. For example, a recording having a transaction code “T302” should be considered as belonging to a “Premium” accounting category in the example of FIG. 4.

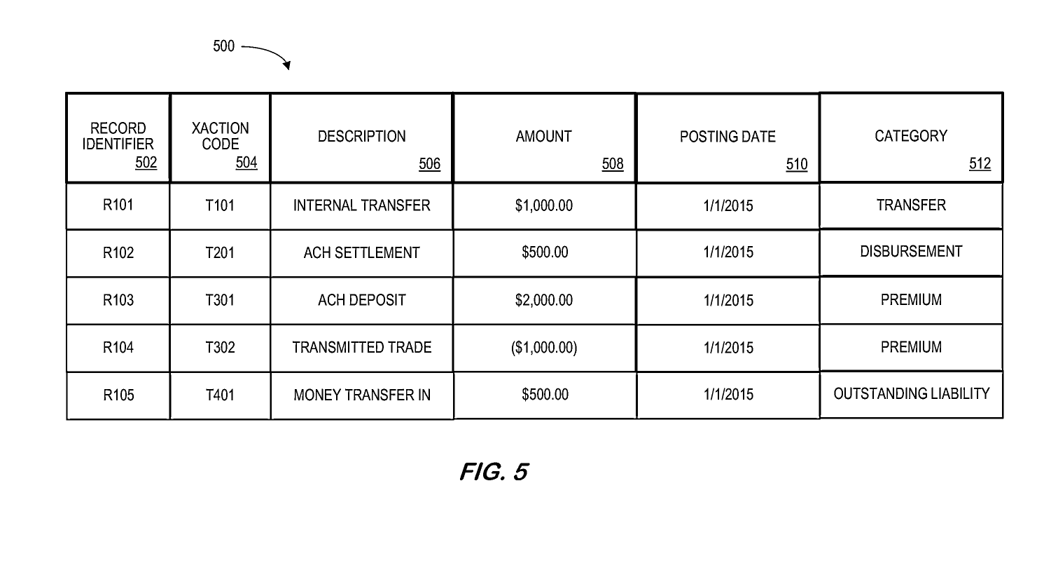

FIG. 5 is a tabular portion of translated transactions 500 according to some embodiments. That is, the translated transactions 500 may represent information after it has been processed by the convertor tool 150 of FIG. 1. The table may also define fields 302, 504, 506, 508, 510 for each of the entries. The fields 502, 504, 506, 508, 510 may, according to some embodiments, specify: a record identifier 502, a transaction code 504, a description 506, an amount 508, and a posting date 510. The information in the translated transactions 500 may be created and updated, for example, based on corresponding information in the inventory report file 300.

The translated transactions 500 further include a category 512 for each record. The category 512 may be a unique alphanumeric code identifying an accounting category, and may, according to some embodiments, be based on or otherwise associated with the category 404 in the data dictionary 400. For example, the record having a record identifier “R104” in FIG. 5 is associated with a “Premium” accounting category (because of the association of transaction code “T302” with that category in the data dictionary 400).

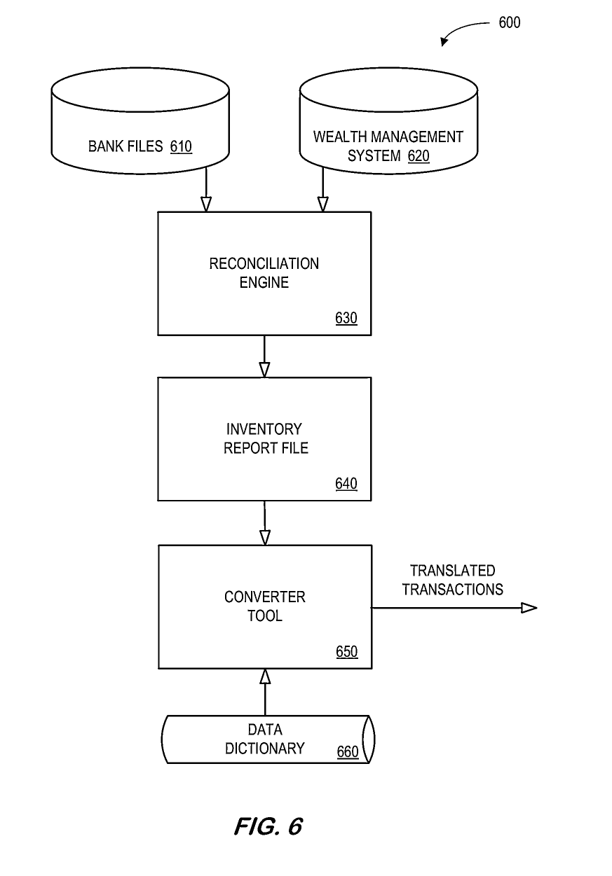

The databases described herein may be associated with various hardware environments. For example, FIG. 6 is block diagram of a system 600 according to some embodiments of the present invention. In this example, bank files 610 may represent cash transactions and information from a wealth management system 620 may represent transaction associated with a processing or change to a customer's account balance. Both types of information may be loaded into a reconciliation engine 630 that will match off bank or cash transactions with processing transactions by the customer. The unmatched items remaining after such a process may represent a current outstanding inventory report file 640. The converter tool 650 may pull the inventory report file 640 on a daily basis. The convertor tool 650 might be associated with a spreadsheet macro that uses a data dictionary 660 to group items in the inventory report file 640 into appropriate accounting categories, such as premium deposits, liquidations (which are disbursements), fees, etc. These grouped item may now be output as translated transactions in a format useful for reconciliation with general ledger accounts and balances and/or for use with financial statements (e.g., to comply with an auditing requirements).

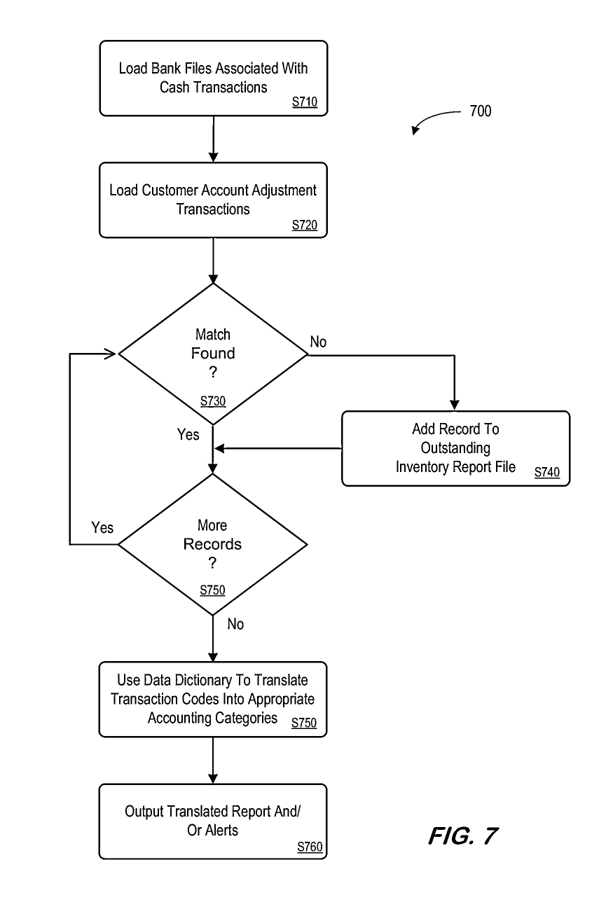

FIG. 7 illustrates a method 700 that may be performed by the elements of the system 600 of FIG. 6 according to some embodiments of the present invention. At S710, bank files associated with cash transactions may be loaded into a record keeping system. At S720, customer account adjustment transactions are also loaded into the record keeping system.

When cash transactions and customer account adjustment transactions cannot be matched, the unmatched record may be added to an outstanding inventory report file at S740. This process continues until no more records are available at S750.

When no more records are available, a data dictionary is used to translate transaction codes in the inventory report file into appropriate accounting categories at S750. A translated report may then be output at S760. According to some embodiments, one or more alerts or notifications may also be output at S750 (e.g., indicating that certain records should be manually reviewed by an accountant or administrator). Further, according to some embodiments, a detailed aging report of suspense related inventories may be generated.

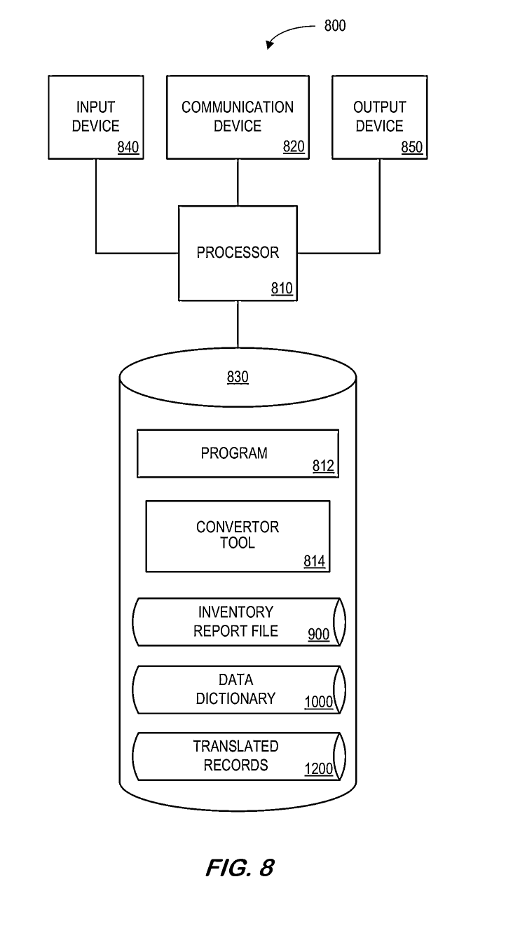

The process of FIG. 7 may be implemented using any number of different hardware configurations. For example, FIG. 8 illustrates a conversion platform 800 that may be, for example, associated with either of the systems 100, 700 of FIG. 1 or 7. The conversion platform 800 comprises a processor 810, such as one or more commercially available Central Processing Units (CPUs) in the form of one-chip microprocessors, coupled to a communication device 820 configured to communicate via a communication network (not shown in FIG. 8). The communication device 820 may be used to communicate, for example, with one or more remote consumer devices or third-party data services. The conversion platform 800 further includes an input device 840 (e.g., a mouse and/or keyboard to enter underwriting rules or decision algorithms) and an output device 850 (e.g., a computer monitor to display aggregated underwriting results to an administrator).

The processor 810 also communicates with a storage device 830. The storage device 830 may comprise any appropriate information storage device, including combinations of magnetic storage devices (e.g., a hard disk drive), optical storage devices, mobile telephones, vehicle computers, and/or semiconductor memory devices. The storage device 830 stores a program 812 and/or convertor tool 814 (e.g., a macro for a spreadsheet) for controlling the processor 810. The processor 810 performs instructions of the programs 812, 814, and thereby operates in accordance with any of the embodiments described herein. For example, the processor 810 may receive or retrieve an inventory report file 900. The inventory report file may, for example, have records representing outstanding transactions associated with a wealth management record keeping system, and each record in the inventory report file may be associated with a transaction code. Information in a data dictionary 1000 may then be accessed by the processor 810, wherein the data dictionary maps transaction codes to accounting categories. The convertor tool 814 may then automatically translate each transaction code in the inventory report file 900 into an appropriate accounting category to facilitate reconciliation of a general ledger account balance.

The programs 812, 814 may be stored in a compressed, uncompiled and/or encrypted format. The programs 812, 814 may furthermore include other program elements, such as an operating system, a database management system, and/or device drivers used by the processor 810 to interface with peripheral devices.

As used herein, information may be “received” by or “transmitted” to, for example: (i) the conversion platform 800 from another device; or (ii) a software application or module within the conversion platform 800 from another software application, module, or any other source.

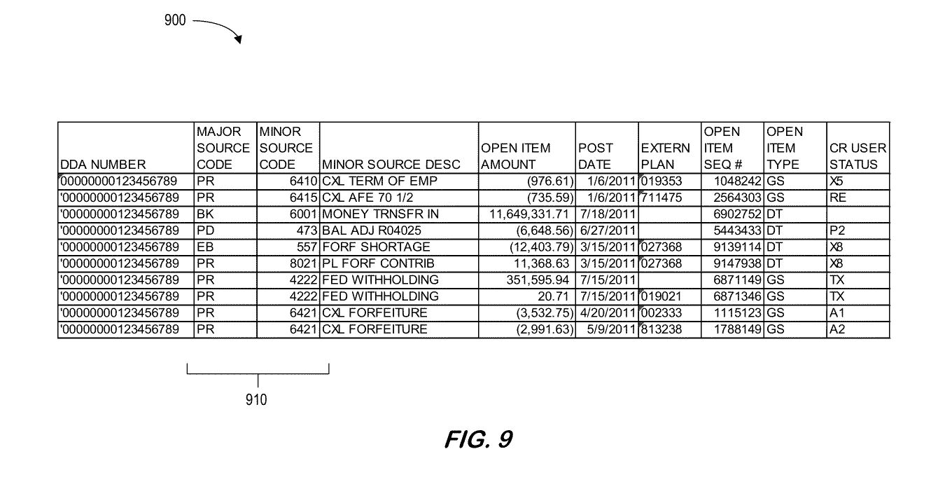

In some embodiments (such as shown in FIG. 8), the storage device 830 stores the inventory report file 900, the data dictionary 1000, and translated records 1200. Examples of the databases 900, 1000, 1200 that might be used in connection with the conversion platform 800 will now be described in detail with respect to FIGS. 9, 10, and 12. Note that the databases 900, 1000, 1200 described herein are only examples, and additional and/or different information may be stored therein. Moreover, various databases might be split or combined in accordance with any of the embodiments described herein.

FIG. 9 is a tabular portion of an inventory report file 900 according to some embodiments. The inventory report file 900 may include unmatched transaction records associated with a wealth management record keeping system. The inventory report file 900 may include, for each transaction, a Direct Deposit Account (“DDA”) number associated with a bank or other financial institution, a description, a monetary amount, a post date, a plan number, an open item number, an open item type, and a user status. According to this embodiment, the inventory report file further includes a two part transaction code 910. In particular, a “Major Source Code” and “Minor Source Code” may represent the transaction code.

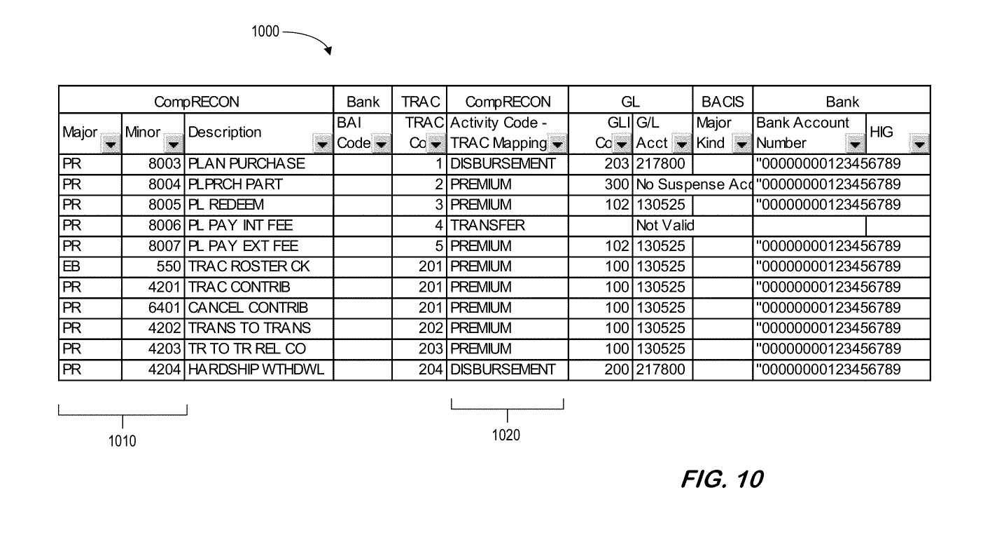

FIG. 10 is a tabular portion of a data dictionary 1000 according to some embodiments. The data dictionary 1000 may be used to map transaction codes to appropriate accounting categories, and may include an entry description, general ledger account identifiers, bank account numbers, etc. In addition, the data dictionary defines an appropriate accounting category 1020 for each transaction code 1010 (e.g., each pair of Major and Minor identifiers).

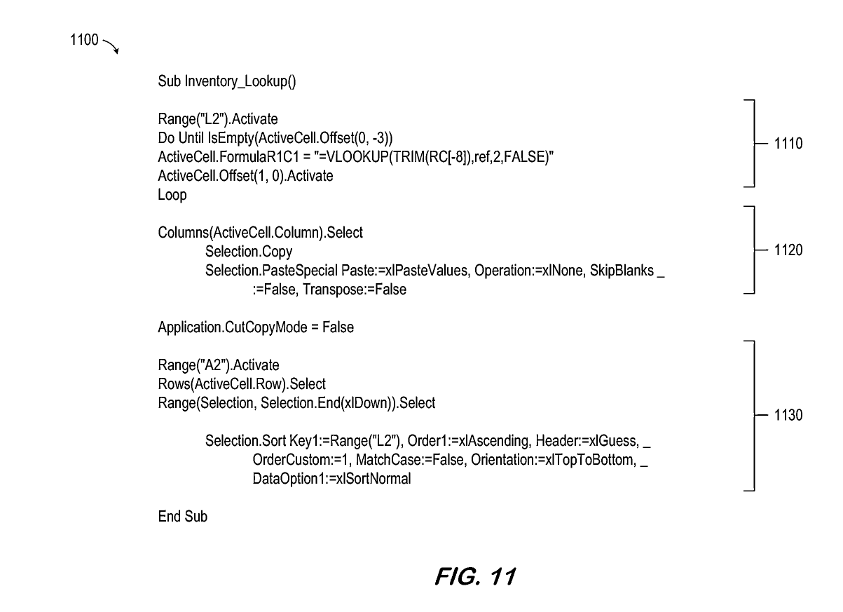

FIG. 11 is an example of a spreadsheet macro 1100 according to some embodiments. The macro 1100 might be associated with the Advanced EXCEL Functionality programming language. The macro includes an initial code portion 1110 that pastes the inventory into an “inventory tab,” and activates cell “L2” (in this example, column L will be used to facilitate definition of the appropriate accounting category). The initial code portion 1110 also includes a loop that puts a VLOOKUP formula into column L for each row. The VLOOKUP (or “vertical lookup”) may search for a value in a column of a table array and return a value in the same row form another column in the table array. The VLOOKUP may be defined as:
VLOOKUP(lookup_value, table_array, col_index_num, range_lookup)
   In the example of FIG. 11, the value of “FALSE” for the range_lookup will cause the VLOOKUP to only find an exact match. A second code portion 1120 in the spreadsheet macro 1100 may paste values of the formula to remove VLOOKUP. A third portion 1130 in the spreadsheet macro 1100 may then sort the range by the value in column L (that is, by the appropriate accounting category).

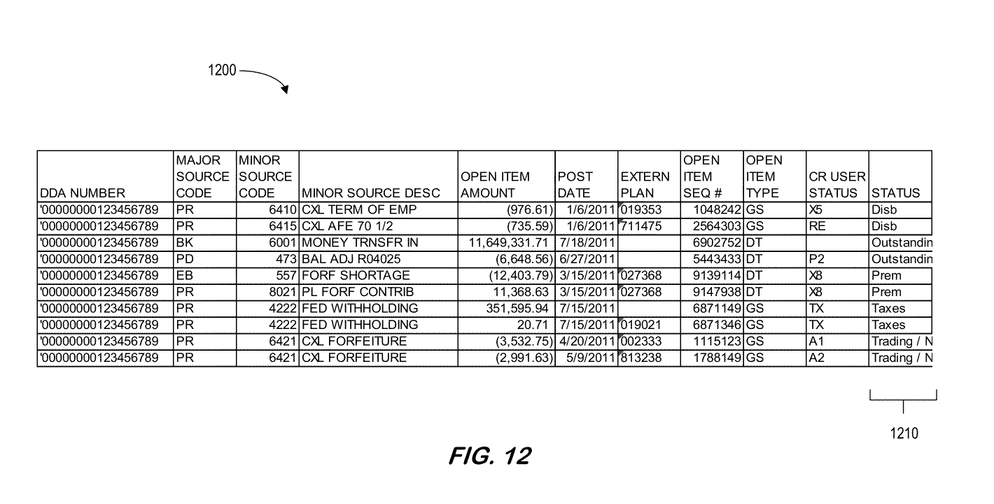

FIG. 12 is a tabular portion of translated transactions 1200 according to some embodiments. That is, the translated transactions 1200 represent the inventory report file 900 after the macro 1100 is executed in connection with the data dictionary 1000. In particular, the translated transactions 1200 include the appropriate accounting category 1210 for each of the records (e.g., “Disb,” “Prem,” etc.).

The information in the translated transactions 1200, including the appropriate accounting category 1210 may be suitable for use in connection with reconciliation of a general ledger account balance. Thus, embodiments may facilitate reconciliation of a general ledger in an efficient and accurate manner

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

Applicants have discovered that embodiments described herein may be particularly useful in connection with supporting audits for mutual funds and similar types of wealth management systems. Note, however, that other types of interactions may also benefit from the invention. For example, embodiments of the present invention may be used in connection with medical records, insurance records, and/or records of a financial institution.

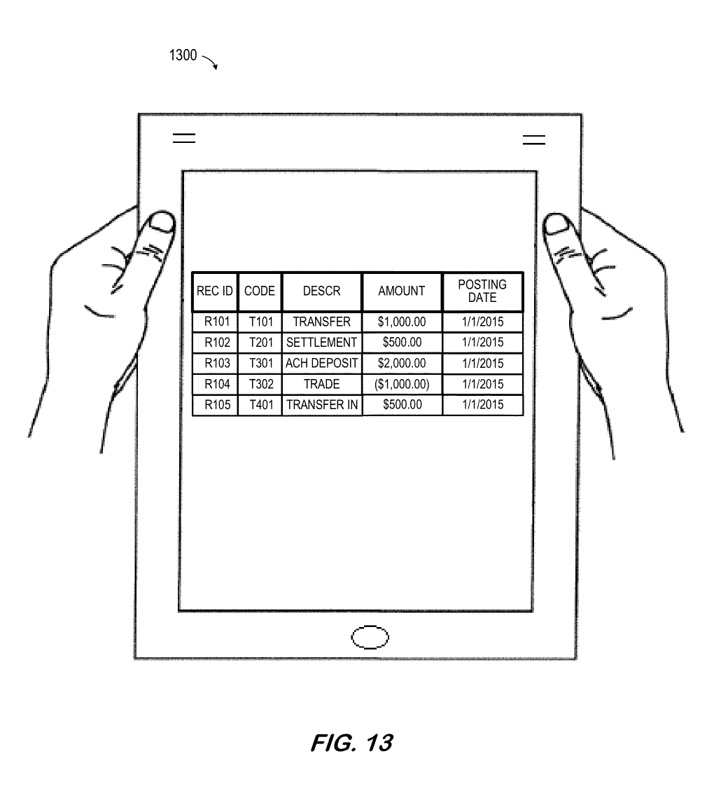

Moreover, some embodiments have been described herein as being accessed via a PC or laptop computer. Note, however, that embodiments may be implemented using any device capable of executing the disclosed functions and steps. For example, FIG. 13 illustrates a display 1300 in accordance with some embodiments described herein. In particular, the display includes a graphical user interface including a tabular portion of an inventory report file according to some embodiments.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system associated with wealth management record keeping, comprising:
a communication device to receive an inventory report file having records representing outstanding transactions associated with wealth management record keeping, wherein each record in the inventory report file is associated with a transaction code;
a computer processor for executing program instructions; and
a memory, coupled to the computer processor, for storing program instructions for execution by the computer processor to:
access information in a data dictionary, wherein the data dictionary maps transaction codes to accounting categories,
automatically translate, by a convertor tool, each transaction code in the inventory report file into an appropriate accounting category to facilitate reconciliation of a general ledger account balance, and
writing an indication of the appropriate account category to a storage device.

2. The system of claim 1, wherein the memory further stores program instructions executable by the computer processor to:
load bank files associated with cash transactions into the record keeping system,
load customer account adjustment transactions into the record keeping system,
match cash transactions with customer account adjustment transactions, and
store unmatched transactions as outstanding transactions in the inventory report file.

3. The system of claim 1, wherein said automatic translating is performed periodically, as a batch process, each business day.

4. The system of claim 1, wherein the converter tool is associated with a spreadsheet macro program that includes a vertical lookup command.

5. The system of claim 1, wherein the accounting categories include at least one of: (i) a premium transaction, (ii) a disbursement transaction, (iii) a fee transaction, (iv) an outstanding liability transaction, or (v) annuity information.

6. The system of claim 1, wherein the wealth management record keeping system is associated with at least one of: (i) wealth annuity management, (ii) a mutual fund, (iii) a 401k plan, (iv) a 403b plan, (v) a 529 plan, (vi) an individual retirement account, (vii) a profit sharing plan, or (viii) life insurance.

7. The system of claim 1, wherein the memory further stores program instructions executable by the computer processor to:
generate a detailed aging report of suspense related inventories.

8. The system of claim 1, further comprising
a reconciliation engine, coupled to the communication device, to output the inventory report file.

9. The system of claim 1, further comprising:
a bank file system coupled to the reconciliation engine; and
a wealth management system coupled to the reconciliation engine, wherein the reconciliation engine outputs the inventory report file based on information received from the bank file system and the weal management system.

10. A computer-implemented method associated with a wealth management record keeping system, comprising:
receiving an inventory report file having records representing outstanding transactions associated with the wealth management record keeping system, wherein each record in the inventory report file is associated with a transaction code;
accessing information in a data dictionary, wherein the data dictionary maps transaction codes to accounting categories;
automatically translating, by a convertor tool, each transaction code in the inventory report file into an appropriate accounting category to facilitate reconciliation of a general ledger account balance; and
writing an indication of the appropriate account category to a storage device.

11. The method of claim 10, further comprising:
loading bank files associated with cash transactions into the record keeping system;
loading customer account adjustment transactions into the record keeping system;
matching cash transactions with customer account adjustment transactions; and
storing unmatched transactions as outstanding transactions in the inventory report file.

12. The method of claim 10, wherein said automatic translating is performed periodically, as a batch process, each business day.

13. The method of claim 10, wherein the converter tool is associated with a spreadsheet macro program that includes a vertical lookup command.

14. The method of claim 10, wherein the accounting categories include at least one of: (i) a premium transaction, (ii) a disbursement transaction, (iii) a fee transaction, (iv) an outstanding liability transaction, or (v) annuity information.

15. The method of claim 10, wherein the wealth management record keeping system is associated with at least one of: (i) wealth annuity management, (ii) a mutual fund, (iii) a 401k plan, (iv) a 403b plan, (v) a 529 plan, (vi) an individual retirement account, (vii) a profit sharing plan, or (viii) life insurance.

16. The method of claim 10, further comprising:
generating a detailed aging report of suspense related inventories.

17. A non-transitory computer-readable medium storing instructions adapted to be executed by a computer processor to perform a method, said method comprising:
receiving an inventory report file having records representing outstanding transactions associated with the wealth management record keeping system, wherein each record in the inventory report file is associated with a transaction code;
accessing information in a data dictionary, wherein the data dictionary maps transaction codes to accounting categories;
automatically translating, by a convertor tool, each transaction code in the inventory report file into an appropriate accounting category to facilitate reconciliation of a general ledger account balance; and
writing an indication of the appropriate account category to a storage device.

18. The medium of claim 17, wherein the method further comprises:
loading bank files associated with cash transactions into the record keeping system;
loading customer account adjustment transactions into the record keeping system;
matching cash transactions with customer account adjustment transactions; and
storing unmatched transactions as outstanding transactions in the inventory report file.

19. The medium of claim 17, wherein said automatic translating is performed periodically, as a batch process, each business day.

20. The medium of claim 17, wherein the converter tool is associated with a spreadsheet macro program that includes a vertical lookup command.

21. The medium of claim 17, wherein the accounting categories include at least one of: (i) a premium transaction, (ii) a disbursement transaction, (iii) a fee transaction, (iv) an outstanding liability transaction, or (v) annuity information.

22. The medium of claim 17, wherein the wealth management record keeping system is associated with at least one of: (i) wealth annuity management, (ii) a mutual fund, (iii) a 401k plan, (iv) a 403b plan, (v) a 529 plan, (vi) an individual retirement account, (vii) a profit sharing plan, or (viii) life insurance.

23. The medium of claim 17, wherein the method further comprises:
generating a detailed aging report of suspense related inventories.
